(19) United States
(12) Patent Application Publication
(10) Pub. No.: US 2002/0138393 A1
(43) Pub. Date: Sep. 26, 2002

(54) Computerized system and method for conducting an online virtual auction

(76) Inventor: Jason G. Tatge, Cordova, TN (US)

Correspondence Address: Dorian B. Kennedy, Baker, Donelson, Bearman & Caldwell, Suite 900, Five Concourse Parkway, Atlanta, GA, 30328, US

(21) Appl. No.: 09/766,528

(22) Filed: Jan. 22, 2001

(51) Int. Cl. G06F 17/60

(52) U.S. Cl. 705/37

(57) ABSTRACT

An auction system and method is disclosed which presents an optional proxy bid designation to a buyer. The buyer may select a maximum proxy bid so that the system automatically enters a bid for that buyer up to the amount designated as the maximum proxy bid.

### FIELD OF INVENTION

The invention relates generally to virtual auctions, and more particularly to a virtual market place being accessible in real-time to many users through a computer network wherein the bidder need not be present to participate in the auction.

### BACKGROUND OF THE INVENTION

Whether an auction is performed over the Internet or in a more traditional setting, they are historically one-dimensional in nature and scope. In other works, an auctioneer attempts to secure a series of progressively higher bids until a highest bid is secured and a sale made. At times a reverse auction is held, whereby the bidding process is done in reverse and eventually the lowest bidder makes the sale.

It is an object of the present invention to add a new dimension to the auction process. In a true, free-flowing marketplace it is not uncommon for an individual or company to be a buyer at one price and a seller simultaneously at a slightly higher price. For example, an agricultural trading company might be a buyer of barge corn at New Orleans at $2.15 per bushel, and at the same time be a seller at $2.19 per bushel. However to date, all Internet auction and trading platforms have been one dimensional in nature. The bid/ask marketplace according to the present invention allows these 2-dimensional transactions to occur simultaneously.

Further, current one-dimensional Internet trading platforms may be able to secure the highest price, or lowest price for a given product. However, from the time the highest price (or lowest price) is obtained until the time the buyer accepts or denies the high (or low) offer price can be several hours, or even days. Another related problem is the fact that a bidder of on-line auctions must constantly review the bidding process to determine whether or not his or her bid is still considered to be the controlling bid. As such, the bidder must constantly update his bid when other bidders also are participating in the auction. If the bidder does not actively follow the bidding process that bidder may not realize that his bid has been overcome by another's bid and the auction may close even though the bidder was willing to submit a higher bid.

Automated systems nave been developed which enter proxy bids for an absentee bidder. These systems however do not provide real time bidding but instead submit one bid at the conclusion of the auction in an amount equal to the proxy bid. For example, a buyer may enter a proxy bid of $75.00 for an item and near the conclusion of the auction the system submits the $75.00 bid eventhough the items current bid is only $68.00 and the next incremental bid level is $68.50. As such, the buyer has submitted a bid which is unnecessarily high.

Accordingly, it is seen that a need remains for a method of auctioning that enables one to constantly update his or her bid without having to physically follow the bidding process in real time. It is the provision of such that the present invention is primarily directed.

### BRIEF DESCRIPTION OF THE FIGURES

FIG. 1 illustrates an overview of a computer network utilized according to a preferred form of the invention.

FIG. 2 illustrates an auction application architecture according to a preferred form of the invention.

FIGS. 3-8 are a series of illustrations showing the monitor screen of a workstation through the different steps of an auction.

### DETAILED DESCRIPTION OF THE INVENTION

With reference next to the drawing, when the system according to the present invention is utilized, the trading platform identifies and keeps track of all participants registered for a given auction. In turn, the auction platform sends a message to each participant telling them whether they have or control the current bid or do not have the bid. Conventional bid/ask markets require that the user refresh their screen to get the latest bid. In contrast, the present invention preferably utilizes Java based bidding screens and automatically transmits bids to all participants as they occur in real-time.

The bidding process in a real-time marketplace can be fast and furious. Bidding does not necessarily occur in even price increments as prices can jump several increments at a time. Conventional systems which have bidders type in bids manually can often cause errors (for example, it would be easy for a person to type in $20.5 instead of the desired $2.05). The graphical interface illustrated by a color bar indicating the current buy bid and current ask bid, also known as sell or offer bid, on a scale according to the present invention allows market participants (buyers or sellers) to change the bid amount graphically through the color bar to a desired bidding level, thereby eliminating any typing and associated errors. A numerical representation (i.e. $2.05) as well as the change in the color bar indicates further price changes. Numerical price changes and the price spread between bid and ask are displayed graphically. Audio feedback, i.e. a beep, when the bid changes, can also be incorporated according to a preferred embodiment of the system according to the present invention.

The look and feel of real-time bidding with graphical interface can take on various forms. Multiple lots, each with its own bidding graphic can be displayed on one screen. In the preferred embodiment, these graphics are displayed as a line graph; a bar chart; or any other suitable graphical interface.

The present invention further incorporates instantaneous scale changes, as the bid/ask prices approach each other. In other words, the system according to the preferred embodiment preferably automatically rescales the graphics to dynamically calculate and represent the changing environment and hence bidding increments. For example, the following illustrates how this would occur:

TABLE 1

| Current Buy | | | |
|---|---|---|---|
| Bid | Current Sell Bid | Bid/Ask Spread | Bidding Increment |
| $100.00 | $150.00 | $50.00 | $5.00 |
| $125.00 | $135.00 | $10.00 | $1.00 |
| $128.00 | $130.00 | $2.00 | $0.25 |

Basically, the starting buy bid is $100.00 and the starting sell bid is $150.00, resulting in a bid/ask spread of $50.00. The system according to the present invention preferably is preprogrammed to use 10 bidding increments in this particular example resulting in an increment of $5.00 for each bid. After further bidding the spread, as indicated in the second entry in Table 1, the bid/ask spread is reduced to $10.00 resulting in a bidding increment of $1.00 being generated. Finally, the bid/ask spread has been reduced to $2.00, however in this particular example the system is provided with a minimum bid increment of $0.25 and hence that is generated and used for final bidding. A trade, and hence both the ask and bid being $129.25, being completed at $129.25 for example. It should be understood that the minimal bid increment is determined by the amount of spread between the buy bid and sell bid, but that it must also maintain standard pricing increments. Also, the minimal increment may be established by a seller or the auctioneer. A mathematical formula may be instituted to derive these minimal bid increments according to the spread.

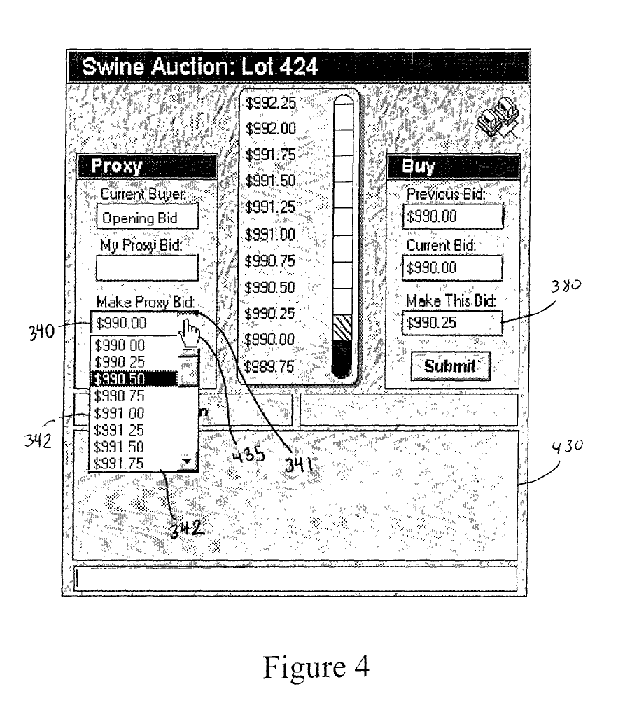

This distinct format allows for a quick and efficient trading platform, and at the same time achieves the best price. Again, it is important to note that the same graphic is scaled accordingly throughout the process, which allows for easy visualization, whether the price spread is $50.00 or $0.50. Alternatively, the scale can remain unchanged (see, FIGS. 4A-9B, for example).

Further, live markets require communications between traders and the market. The system according to the present invention has the ability to instantaneously send discrete messages to an individual participant or a global message to all (although a verbal transmission will be achievable when broadband technology becomes more widely adopted by our market participants). Participants likewise will be able to communicate back to the market in private. For example, a large 1,000,000-unit order, with 100,000-unit minimums is occurring across a platform according to the present invention. The winning bidder decides to take 400,000-units of the order, and now the remaining 600,000 units must offered. The market manager can send a discrete message to the winning bidder and in turn discover that their bid was only good for 400,000 units. The market manager can then tell participants that 600,000 units are still up for play, and continue the market. The present invention can support various auction types, including: Multi-lot Regular and Reverse Auctions; Single-lot Regular and Reverse Auctions; Multi-lot and Single-lot Bid/Ask Auctions; and Multi-lot Dutch Auctions (fully-automated).

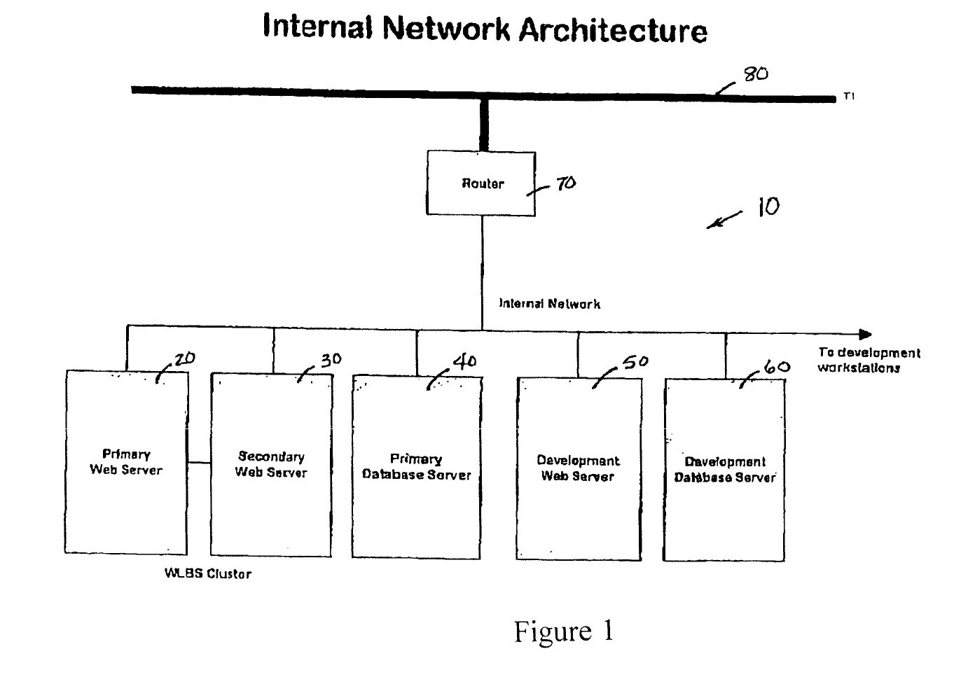

Referring now to the numerous figures, wherein like references identify like elements of the invention, FIG. 1 illustrates an overview of a computer network 10 utilized according to a preferred form of the invention. The network 10 includes a primary web server 20, a secondary web server 30 (which collectively form conventional Windows Load Balancing Services Cluster as is well known), a primary database server 40, a development web server 50, and a development database server 60 all connected through a router 70 to a computer network 80. In the preferred form the computer network 80 takes the form of the Internet with a connection being made by a T1 line for example.

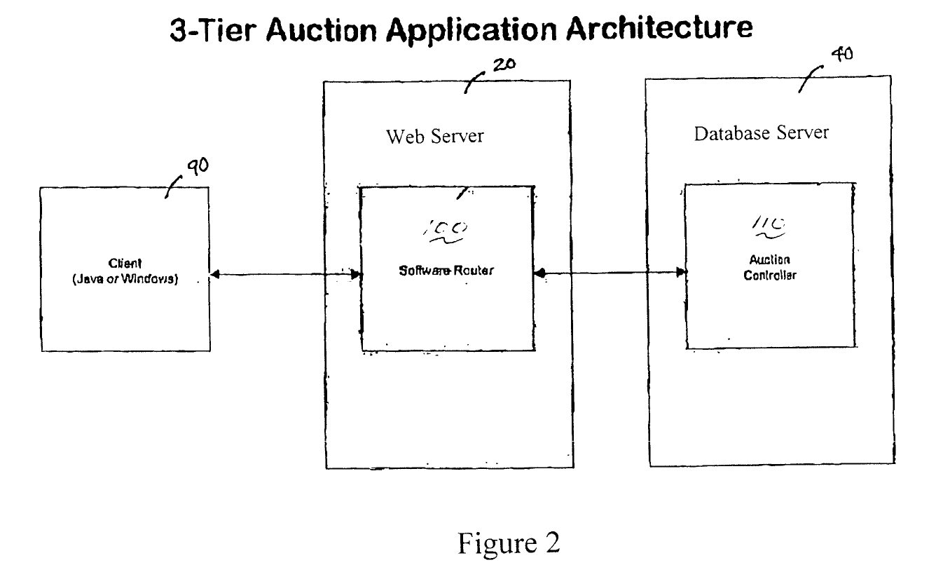

Referring now also to FIG. 2, therein is illustrated an auction application architecture used according to a preferred form of the invention. The system according to the present invention includes a client or user interface 90, routing software 100 preferably implemented on the web server 20 and auction controller software 110 preferably implemented on the database server 40. It should be understood the interface 90 and routing software 100, and the routing software 100 and auction controller 110 are communicable with one another. The web servers preferably used include dual Pentium III processors, are redundant and include Raid 5 drives which provide data striping at the byte level and also stripe error correction, as is well known. Automatic database mirroring and daily tape backups are also preferably implemented.

The Client 90 preferably runs as a Java applet in browser software locally at a user's site. There are preferably separate applets available for single (e.g., PVA) and multi-lot auctions and for auction management. The applets preferably connect directly to the Software Router 100 using TCP/IP sockets and a proprietary transfer protocol. The applets preferably continually listen for messages from the Software Router 100 and monitor connection viability. The applets are preferably compatible with industry standard browser software (i. e., Microsoft Internet Explorer and Netscape Navigator) and support dynamic HTML and client script for online auction lot listings and forms-based input (new listings). The applets are preferably implemented using “pure” Java 1.1 for bidder applications which results in Netscape 4.06 and IE 4.0 and greater browsers being supported.

The software router 100 preferably maintains client socket connections and stores a list of IP addresses of all connected users. The software router 100 further preferably handles messaging to and from clients 90 and the auction controller 110, however does not perform any of the business (auction) logic.

The software router 100 runs as a custom Microsoft Windows NT service. Windows Load Balancing Services (“WLBS”) provides for redundancy and high-availability so client (90) connections are maintained even in the event of a back-end server (database server 110) disruption.

The auction controller 110 preferably runs under Microsoft Transaction Server, handles client messages sent through the Router software 100, returns all relevant auction information to clients 90 via the router software 100, handles all database updates and notifies clients 90 of changes via the router software 100, and checks and maintains database state. The database server 110 is preferably implemented using SQL Server 7.0. The auction controller 110 preferably runs under Microsoft Transaction Server for efficiency (connection pooling) and automatic transaction support.

The system according to the preferred form of the present invention is readily scalable as it conforms to Microsoft Windows Distributed internet Applications Architecture (Windows DNA), the architecture permits multiple auctions to be run concurrently, all transmitted messages are very small (<<1K) which provides for very low bandwidth connections and thousands of simultaneous bidders, and Windows Load Balancing Services (WLBS) allows for multiple Web services and Software Router services to be run simultaneously.

According to a preferred form of the invention, a client 90 can be initialized as follows. The user connects via a web browser after a login and password are validated and an auction is selected. A Java Bidder Applet (JBA) 90 loads from Web Server 20 and establishes a direct socket connection to the Software Router (SR) 100. The JBA 90 sends a request to the SR 100 for auction info and supplies buyerid (buyer identification) and auctionid (auction identification) (i.e. data to identify th operator of JBA 90 and the auction the operator of JBA 90 wishes to join). The SR 100 retrieves auction and active lot information from Auction Controller (AC) 110 and sends it back to JBA 90.

Once initiated, bids can be placed in accordance with the following preferred method. The JBA 90 sends a message to the SR 100 to place a bid and supplies auctionid, lot number, bid amount, and buyerid (same information as before plus the amount and price). The SR 100 sends the bid request to the AC 100 which checks to see if the bid is acceptable. If so, the AC 110 posts the new bid in the database and sends a message back to SR 100. The SR 100 in turn sends the message back to bidder JBA 90 indicating the bid was accepted and broadcasts the new bid amount to all connected JBA clients 90. If not, the AC 110 sends an error message back to SR 100, which routes an error message back to bidder JBA 90.

Preferably, there is a corresponding JAVA Auction Applet (“JAA”) which enables authorized users to manage auction for example by: starting or stopping an auction; sending personalized or global messages to bidders; editing lot information including: lot status, asking bid, etc.; and disabling bidders. A JAA preferably communicates through the software router 100 with the AC 110 in the same manner as a JBA. Preferably, all actions performed through a JAA and impact an auction causes the SR 100 to send updated auction data to all bidders (JBA's).

Both auction management (JAA) and bidding (JBA) use the same messaging protocol, although many more messages are available to the auction management applications. The protocol utilized preferably is designed to minimize an amount of information transmitted across the Internet, so that many simultaneous users can participate in auctions without saturating the connection to the SR 100. Moreover, the messaging protocol is preferably extensible so that new functions can be made available to bidders and auction managers as the need arises.

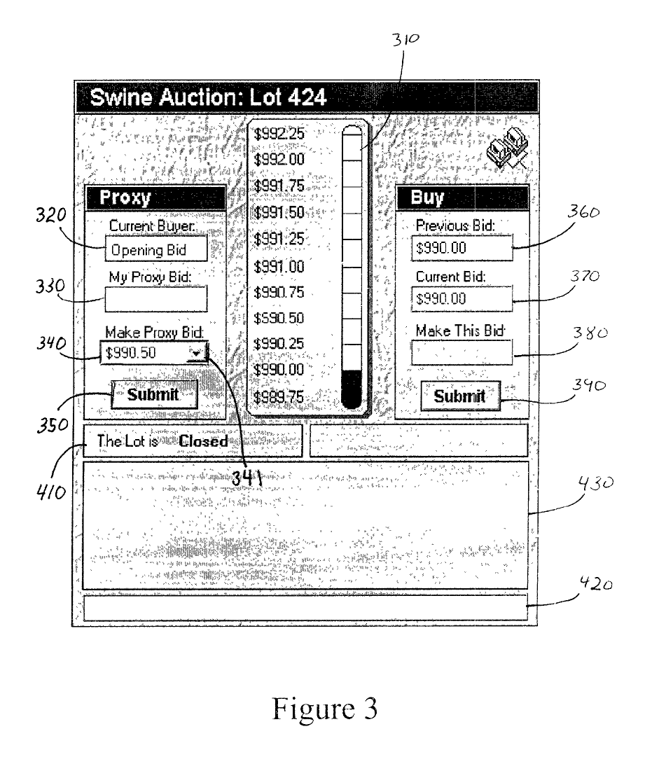

Referring now to FIG. 3, therein is illustrated a user interface 300 according to a preferred form of the present invention. The interface 300 includes a bid selector (graphical scale element) 310, proxy current buyer window 320, a my proxy bid window 330, a make proxy bid window 340, selector 341 and optional amounts screen 342 (shown in FIG. 4), and a new bid submit button 350. Similarly, the interface 300 further includes a buy previous bid window 360, a buy current bid window 370, a buy make this bid window 380, a new buy bid submit button 390. The interface 300 further includes a lot status indicator window 410, a chat window 420 and a chat history window 430. The computer monitor also displays a conventional, movable screen cursor 435 the position of which is manually controlled by the user through movement of the computer mouse, entry by key pad or other similar device, and the operation of which is controlled by the computer operating system.

With continued reference to FIG. 3, there is illustrated an example of an automatic auction wherein the starting buy offer (bid) is $990.00 as shown in the buy current bid window 370 and graphically upon the bid selector 310. The system automatically sets the monetary amount shown in the buy make this bid window 390 to the next increasing incremental level of $990.25. Graphically, the bid selector 310 also incrementally illustrates the prospective new buy bid amount of $990.25. It should be noted that the difference between the current buy bid of $990.00 and the next incremental buy bid amount of $990.25 on the bid selector 310 is colored or shaded, herein cross-hatched, differently from that of the current bid so that users can readily identify the difference, as shown in FIG. 4.

The auction may be conducted by the bidder physically entering a new bid amount through either the submission of the automatically generated incremental bid shown in the make this bid window 380 or by entering a larger amount than the automatically generated incremental bid in the make this bid window 380. As described further herein, the bidder may forgo the manual entering of bid and instead employ the present invention to automatically submits bids as described in detail hereinafter.

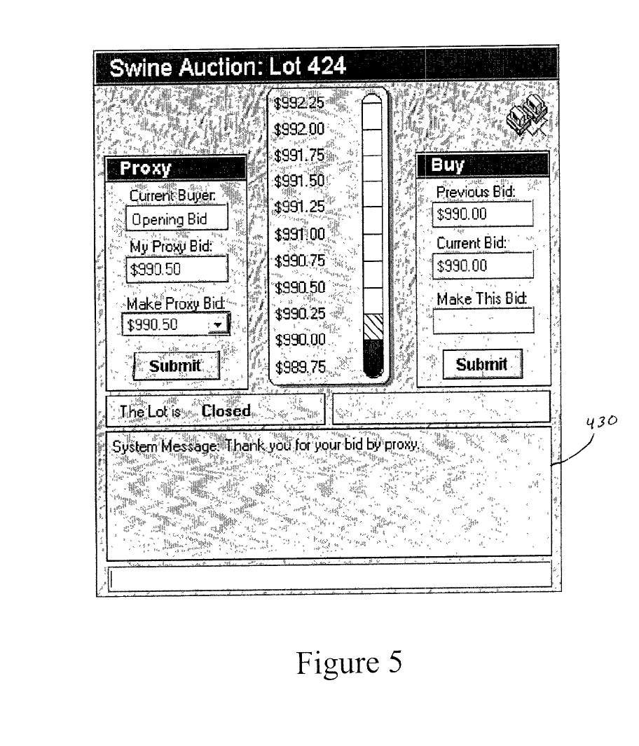

With continued reference to FIG. 4, the first buyer may designate a proxy bid by moving the cursor 435 to the make proxy bid window 340 and clicking upon its selector key 341 to display or pull down the optional amounts screen 342. With the use of the cursor 435 the first buyer selects a desired proxy bid amount by highlighting the desired monetary amount. The highlighted amount is then entered into the system by moving the cursor to and clicking upon the proxy submit button 350, after which the monetary value is displayed in the make proxy bid window 340 and a message may be displayed in the chat history window 430 acknowledging the acceptance of the proxy bid, as shown in FIG. 5. The system places with amount in memory for future use in providing proxy bids for that select buyer.

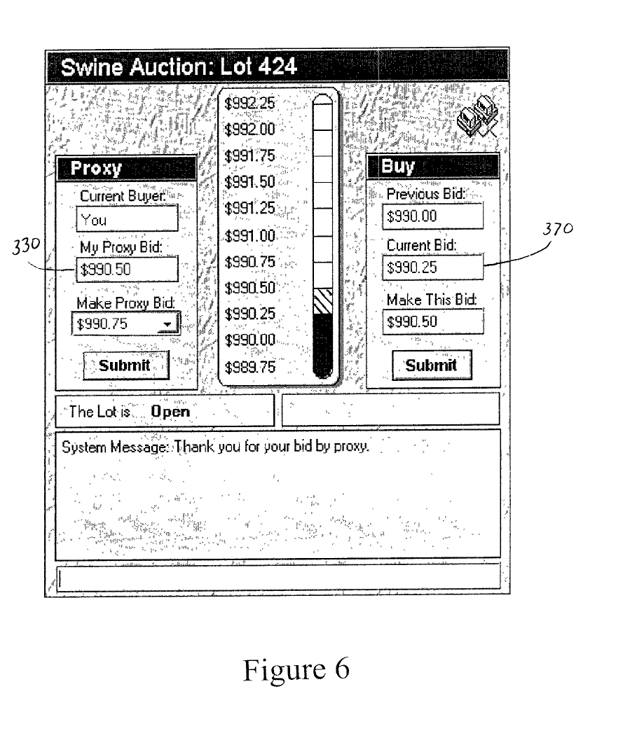

Should another or second buyer enter a bid amount of $990.25, as shown in FIG. 6, the computer system in turn will automatically submit a proxy bid for the first buyer in an amount equal to the next incremental level, here an bid amount of $990.50, in order to re-establish the first buyer as the current buyer. As such, the first buyer need not be present in order to submit a bid to control the current bid amount of the auction.

Should the second buyer or another new buyer submit a new bid higher than the first buyer's proxy bid, as shown by the current bid window 370 amount of $990.75 exceeding the proxy bid amount of $990.50, the system highlights the my proxy bid window 330 so that the buyer may immediately recognize that his or her proxy bid has been surpassed and therefor no longer utilized within the auction.

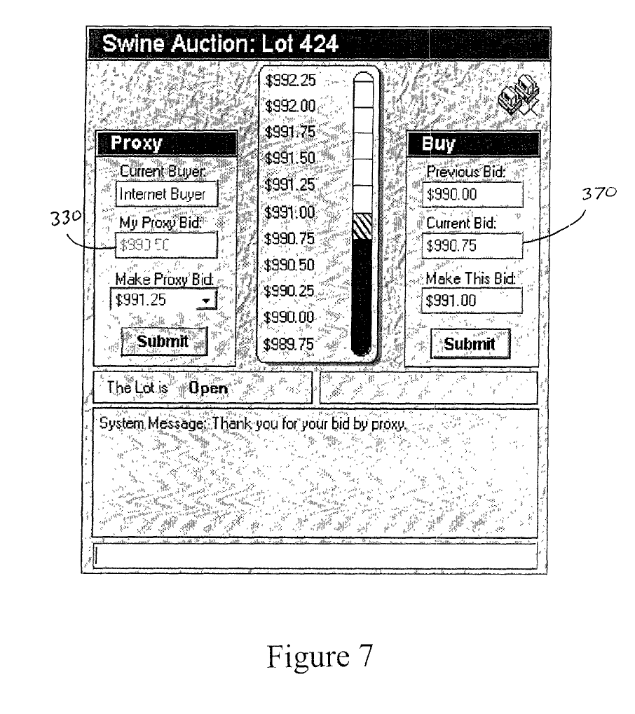

As shown in FIG. 7, the first buyer may re-enter a new proxy bid in an amount greater than the current bid amount in order to regain participation in the auction by proxy. Here, the first buyer has entered a proxy bid amount of $991.25, in the manner previously described.

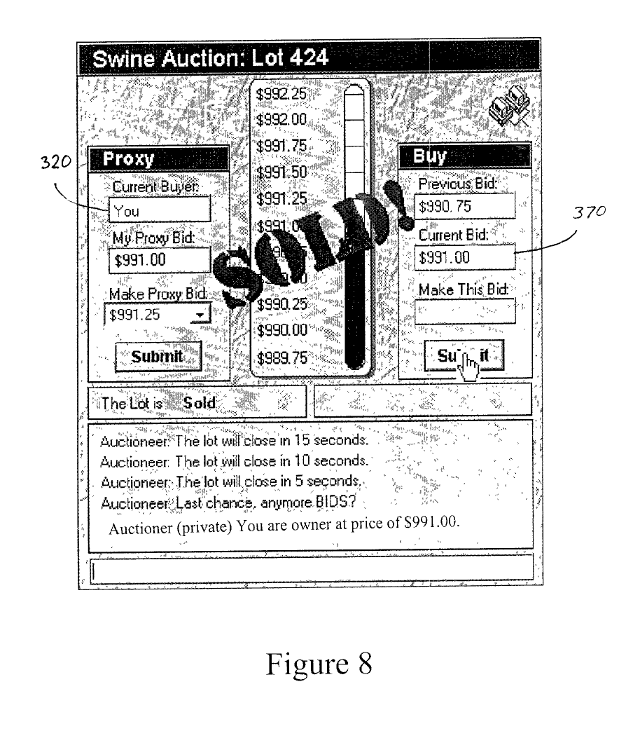

During the course of the auction, the computer automatically submits incremental bids for the first buyer until either the proxy amount is reached or the auction bidding is closed. As shown in FIG. 8, with the closing of the auction the monitor shows that the first buyer gained control of the current bid by the indication of “YOU” in the proxy current buyer window 320 with a winning bid of $991.00 displayed in the my proxy bid window 330 and the current bid window 370.

It should be understood that the computer system may submit one or more proxy bid lower than the maximum proxy bid shown in the make proxy bid window 340 should the auction cease prior to the current bid amount reaching that maximum proxy bid amount. As just described, a buyer may enter a proxy bid in an amount equal to one or several incremental levels higher than the current bid amount and then physically remove himself from the bidding process, i.e. the computer workstation. The system will incrementally increases the buyer's bid so that the buyer is maintained as the current bidder up to the maximum level designated by that buyer, without the buyer being present or without the buyer having to manually enter each bid. Obviously, the system may have several buyers each submitting a proxy bid amount for a select auction. In the event a second buyer submits a proxy bid equal to a previously entered proxy bid of a first buy the computer system will reject the second buyer's bid.

It should be understood that the present invention may be used in connection with a global computer network system interconnecting multiple remote users each having a computer or workstation or with a central computer system having multiple video workstation monitors.

It thus is seen that a new method of auctioning and system for conducting auctions is now provided that has distinct advantages over the prior art. While the invention has been described in detail with particular reference to the preferred embodiments thereof, it should be understood that many modifications, additions and deletions, may be made thereto without departure from the spirit and scope of the invention as set forth in the following claims.

1. A method of conducting an auction utilizing a network computer system connectable to a plurality of monitors comprising the steps of:
(A) displaying a current bid amount upon a computer monitor reflecting a monetary value;
(B) enter a proxy bid amount greater than the current bid amount into computer memory for a select user;
(c) automatically submitting a bid for the select user in an amount one bid level incrementally greater than the current bid amount in response to another bidder gaining the controlling bid in the auction; and
(d) repeating step (c) until the auction is closed or the current bid exceeds the proxy bid amount.

2. The method of conducting an auction of claim 1 wherein the method also includes the step of displaying an indication of whether or not the select user's bid is the current bid upon the monitor of the select user.

3. The method of conducting an auction of claim 1 further comprising the step of displaying the proxy bid upon the monitor of the select user.

4. The method of conducting an auction of claim 1 further comprising the step of displaying a plurality of possible proxy bids upon the monitor from which the user may select a desired proxy bid amount.

5. A method of conducting an auction utilizing a networked computer system having a plurality of coupled monitors, the method comprising the steps of:
(A) displaying a current bid amount upon the coupled monitors;
(B) displaying a plurality of possible proxy bids upon the coupled monitors;
(C) having a select user select a proxy bid from the plurality of proxy bids displayed upon the select users monitor;
(D) entering a proxy bid selected by the select user into the networked computer system; and
(E) automatically submitting a bid for the select user in an amount greater than the current bid in response to another user entering a bid which qualifies as a new current bid.

6. The method of claim 5 further comprising the step of (F) repeating step (E) until the auction has concluded or the current bid amount exceeds the select user's proxy bid amount.

7. The method of conducting an auction of claim 5 wherein the method also includes the step of displaying an indication of whether or not the select user's bid is the current bid upon the monitor of the select user.

8. The method of conducting an auction of claim 5 further comprising the step of displaying the proxy bid upon the monitor of the select user.

9. The method of conducting an auction of claim 5 further comprising the step of displaying a plurality of possible proxy bids upon the monitor from which the user may select a desired proxy bid amount.

10. A system for auctioning goods between remote users and an auction service provider comprising:
(A) a host computer network, including database server means to electronically store auction data and means to access and transmit auction data in response to user commands;
(B) remote computer workstations including a video monitor, means to send user commands to the host computer network, and means to receive and display on the video monitor the auction data from the host computer network;
(C) communication network means for electronically linking the computer workstations to the host computer network;
(D) means for displaying a current bid upon the remote computer workstation video monitors;
(E) means for entering a proxy bid amount into the system for a select user; and
(F) means for automatically entering a bid incrementally greater than the current bid but less than or equal to the proxy bid amount for that select user in response to another user gaining control of the current bid.

11. The system of claim 10 further comprising means for displaying the select user's proxy bid.

12. The system of claim 10 further comprising means for displaying a plurality of possible proxy bids.

13. The system of claim 10 further comprising means for determining whether or not the select user's bid is the current bid.

14. The system of claim 13 further comprising means for displaying an indicator indicating whether or not the select user's bid is the current bid.

15. A system for auctioning goods comprising,
a networked computer system having a plurality of monitors;
means for displaying a current bid upon the remote computer workstation video monitors;
means for entering a proxy bid amount into the system for a select user; and
means for automatically entering a bid incrementally greater than the current bid but less than or equal to the proxy bid amount for that select user in response to another user gaining control of the current bid.

16. The system of claim 15 further comprising means for displaying the select user's proxy bid.

17. The system of claim 15 further comprising means for displaying a plurality of possible proxy bids.

18. The system of claim 15 further comprising means for determining whether or not the select user's bid is the current bid.

19. The system of claim 18 further comprising means for displaying an indicator indicating whether or not the select user's bid is the current bid.
